(19) United States
(12) Patent Application Publication
(10) Pub. No.: US 2003/0058643 A1
(43) Pub. Date: Mar. 27, 2003

(54) Apparatus and method for light absorbing

(76) Inventors: James Barlow, Las Vegas, NV (US); Richard E. Albrecht, Chapel Hill, NC (US)

Correspondence Address: Charles H. McCrea, Jr., Mikohn Gaming Corporation, P.O. Box 98686, Las Vegas, NV, 89193-8686, US

(21) Appl. No.: 09/964,004

(22) Filed: Sep. 25, 2001

(51) Int. Cl. F21V 5/08

(52) U.S. Cl. 362/246; 362/240; 362/241; 362/249; 362/245

(57) ABSTRACT

Absorbing ambient on a visual display with a support and at least one board on the support with a driving circuitry therefor. A plurality of light sources on each board are electrically coupling thereto. A light absorber mounted between the board and about the light sources shaped to reduce reflection of ambient light received and to prevent the ambient light from radiating. At least one narrow crevice for absorbing light and light reflective surfaces opposed at an acute angle to receive ambient light and reflect toward the narrow crevice positioned whereat the pairs of light reflective surfaces join. The light absorber with adjacent pairs of opposed light reflective surfaces joined at a plurality of sharp edges facing front so if viewed in cross section the pairs appear as a series of “WWW” with a slight arc such that when viewed in cross section the curvature is dished.

### BACKGROUND OF THE INVENTION

The present invention relates, in general to visual displays and, more particularly, to a visual display with light sources for a low-cost visual display using groups of light emitting diodes with light absorbers facing forwardly for control of ambient light.

Visual display systems exist providing moving images in color, for example, a television show or videotape and such display signs have not provided vivid video images, especially those that are used outdoors. Previous signs designed for outdoor use have been prohibitively expensive to operate, to purchase, and to maintain. Lack of brightness is a serious problem for prior outdoor display signs. Light from other sources, especially other signs, the sun, the moon and other lights on the ground or on adjacent buildings reduces the ability of viewers to perceive the pictures displayed by the sign. These outdoor display signs have of a plurality of lighting units, some of which are turned off, and therefore black, at any particular moment, and some that are illuminated at various brightness levels in order to show the picture.

U.S. Pat. No. 4,621,898 has a radiant energy filter formed from a transparent plate for a high filtration efficiency. The plate has a plurality of etched grooves with a light absorbency for energy radiating toward the grooves from within the plate. Therefore, light entering the plate from an angle that would cause it to impinge upon the grooves is highly attenuated and light entering the plate and not impinging upon the grooves is attenuated only by the optical characteristics of the plate. Thus there is attenuation of light entering from beyond a view range, as compared with light entering from within a view range. The background of this patent is of particular interest with respect to attenuation filters and so it and the entire disclosure of U.S. Pat. No. 4,621,898 is incorporated herein by reference and made a part hereof.

U.S. Pat. No. 5,745,293 has a light trap for a parallel light beam includes an entry with a frustoconical opening and a conical body attached to a back wall of the trap. The opening narrows with a cone angle from the outside towards the inside and has at the outside its diameter equals the diameter of the light beam. The conical body reflects light uniformly in all directions. Thus, unwanted light is a nuisance if it can disturb the processing operations by generating spurious images in processing devices or by modifying the luminous intensity in instruments for measuring intensity.

U.S. Pat. No. 4,142,781 has a thin synthetic material plate of fluorescent materials to trap or collect ambient light. The trapped light is sent effectively to exit visibly and measurably at arbitrary points on the plate. A fluorescent plate of this type in passive electro-optical displays, that function as light valves, create a visual display having an increased ambient brightness adaptive illuminous density as electrically regulated or controlled between a light transmissive state and a light scattering or blocking state.

U.S. Pat. No. 5,877,829 has an LC display with a light source, a first optical element for collimating light emitted from the source and restricting the direction of emission of the light entering the first optical element to the direction of the normal axis thereof. The first optical element is between and parallel to the light source and the LC display so illumination is substantially by light travelling along the normal axis of the LC display. The directionality of the emission from the first optical element determines the directionality of the light going out has the highest intensity of the LC display. If seen from any other direction, no light reaches the observer, so that the LC display seems black as if the light source was not activated. By using such a first optical element having directionality, it becomes impossible to observe the display content from directions other than the intended direction, regardless of the narrow or broad viewing angle characteristics of the LC display.

U.S. Pat. No. 5,882,105 has a visual display lighting system of a series of individual lighting modules each with a printed circuit board containing drive circuitry and a plurality of light sources wherein each module has a reflector unit for each light source and a covering lens. A pair of retainers lock to the ends of a lighting panel to hold the module in the system. The retainers quickly release from the ends when the module is removed from the front of the system. The lighting panel has clips for locking the printed circuit board and it holds the plurality of light sources into the lighting panel. The printed circuit board can be quickly released and removed from the rear of the system.

U.S. Pat. No. 5,947,592 has a visual display with a lighting unit including a reflector that is nearly completely sealed and has a reflecting surface that spreads the emitted light about eight degrees from the plane of circumference of the reflector. To cool the lighting unit, air is directed along the rear surface of the sealed reflector so a small amount of the air enters the sealed reflector, causing a buildup of pressure inside the reflector and preventing any additional air from entering the reflector. The lighting units are attached to the visual display at a downward angle of about eight degrees from the horizontal.

The disclosures of these listed patents are incorporated by reference and made a part hereof.

Ambient light reduces the contrast of outdoor signs in two ways. First, when a lighting unit is off, the blackness of the lighting unit is only as dark as the ambient light reflected from the unlit portions of the visual display. Second, where it is lit, colors mix with the ambient light and tend to wash out the richness of the visual display. Thus, external light diminishes the contrast of the picture, causing the viewer to have difficulty perceiving the picture being displayed, especially when that picture is a video or moving picture in color. Thus, a need exists for a lighting unit that will increase the contrast ratio of a visual display, without using expensive components. The contrast ratio is the sum of the light from the visual display plus the ambient light reflected divided by the ambient light reflected.

A need remains for large visual displays capable of showing moving images that can be located outdoors at remote locations such as on a building or on a free standing pylon or located indoors in large buildings such as arenas or casinos are conventionally available. All such signs are subject to ambient light that reduces the contrast and thus apparent brightness of the light emitting diode display.

A need exists to enhance the apparent brightness of the light emitting diodes of the display sign when subject to ambient light and seen from the front of the sign. Groups contain a number of light emitting diodes and the electronic drive circuitry associated therewith and are coupled together into large signs driven by processors to display varying images, such as a very large television picture.

A need also exists to build a universal sign with a large visual display showing moving images that can mounted to a variety of structures without regard to if the groups in the sign are subject to varying ambient light conditions. The sign with an enhancement to reduce or eliminate reflection or glare due to those ambient light conditions.

Added to difficulties in seeing moving pictures on outdoor signs under ambient light that wash out the light from the sign, viewers often find it difficult to see the picture when viewed from an angle other than directly in front of the sign. For instance, if viewed by standing below and close to the sign or passing by the side of the sign, most of the light radiated from the light sources is directed from the front of the sign or is diffused too far around the edges of the light sources.

Under the teachings of the present invention, a visual display is disclosed solving the above needs by providing light sources that are surrounded by a light absorber to reduce or eliminate ambient light reflections and increase the contrast ratio. Affordable light sources used in visual displays must provide highly visible moving pictures at the NTSC standard 30 images per second for indoor and outdoor lighting conditions. The light sources have a downward angle of about eight degrees from the horizontal to have bright and consistent images for viewers below or at a distance from the visual display.

In addition, a need exists for a method to easily remove dust from the light sources and their surrounds which could reflect ambient light or reduce light output from the light emitting diodes.

### SUMMARY OF THE INVENTION

A visual display is disclosed comprised of a series of individual light sources. Each of the light sources couples to a board such as a printed circuit board containing drive circuitry and a plurality of light sources. If the light sources are incandescent each module thereof also includes a lighting panel that typically has a reflector unit for each light source and a covering lens. The preferred visual display of the present invention has light emitting diodes as the light sources. Light absorbers are included about the light sources for highly efficient light output with maximum control of ambient light reflection. As the visual displays are mounted above the viewers, each is directed at an angle to the ground so that the pictures displayed can be easily seen by viewers. Light absorbers are preferably mounted to surround the light source, either incandescent or emitting diodes. For light emitting diodes are used a group may consist of three or more carried on a printed circuit board each by its electrical coupling terminals.

The visual display has preferably a video, a message board, or combination of both. The visual display may have any type of plurality of light sources as a signal such as a stop and go light, automotive turn or brake signal lights or cautionary road or traffic lights which might be impaired by reflection of ambient light. Thus, the reduction of the effects of ambient light on the visual display increases the visibility of the information delivery, minimizes the amount of energy required to provide an adequate display and improves clarity all at less cost.

A support preferably mounts the visual display in position for observation of the visual display from locations generally in front of the visual display. At least one board on the support may include driving circuitry for the visual display. A plurality of light sources are most preferably carried on each board and each light source has terminals for electrically coupling to the board so each board holds at least part of the plurality of light sources. Each of the light sources can include a plurality of light emitting diodes. Each board might include a printed circuit having electronic drive circuitry for controlling the delivery of power to the plurality of light emitting diodes.

A light absorber preferably mounts between the board and about the plurality of light sources. The light absorber most preferably is configured for surrounding each of the plurality of light sources. The light absorber might be shaped with at least one narrow crevice for absorbing ambient light received by the visual display from locations generally in front of the visual display and to prevent the ambient light from being radiated therefrom for observation. The light absorber may have a plurality of light reflective surfaces facing locations generally in front of the visual display. Pairs of light reflective surfaces are preferably opposed at an acute angle to receive ambient light and reflect it there between and toward the narrow crevice positioned whereat the pairs of light reflective surfaces join. The light absorber adjacent pairs of opposed light reflective surfaces preferably join at a plurality of sharp edges facing front of the visual display. If viewed in cross section the plurality of adjacent pairs of opposed light reflective surfaces preferably appear as a series of connected “WWW” configurations. The plurality of sharp edges preferably face locations generally in front of the visual display such that adjacent pairs of opposed light reflective surfaces curve in a slight arc if viewed in cross section. The curvature may be dished for trapping ambient light from locations generally in front of the visual display so that dark area appears about each of the light emitting diodes during observation. The plurality of sharp edges may split received ambient light and the pairs of reflective surfaces in combination with the narrow crevices located inwardly of the plurality of sharp edges and positioned closer to the board trap received ambient light. The plurality of sharp edges are preferably located generally horizontal and the plurality of light sources having a light pattern of that is ovoid toward locations generally in front of the visual display such that the ovoid pattern has a longer horizontal dimension.

A method of absorbing ambient received on a lighted visual display may have steps including surrounding each of the plurality of light sources with the light absorber disposed for observation from locations generally in front of the visual display. The step of shaping the light absorber to reduce reflection of ambient light received by the visual display from locations generally in front of the visual display prevents the ambient light from being radiated therefrom for observation. Including on the light absorber at least one narrow crevice for absorbing light is a step in the method. The preferred steps of having on the light absorber a plurality of light reflective surfaces facing locations generally in front of the visual display and mounting pairs of light reflective surfaces opposed at an acute angle to receive ambient light and reflect it there between and toward the narrow crevice positioned whereat the pairs of light reflective surfaces join. The steps of providing the light sources with a plurality of light emitting diodes and mounting the board includes a printed circuit having electronic drive circuitry for controlling the delivery of power to the plurality of light emitting diodes are most preferred. The further step of joining adjacent pairs of opposed light reflective surfaces with a plurality of sharp edges facing locations generally in front of the visual display may be practiced. The step of viewing in cross section the plurality of adjacent pairs of opposed light reflective surfaces may be seen as a series of connected “WWW”configurations with the plurality of sharp edges facing locations generally in front of the visual display. The plurality of sharp edges might split received ambient light so that the pairs of reflective surfaces in combination with the narrow crevices located inwardly of the plurality of sharp edges and positioned closer to the board may reduce received ambient light.

The method may include the steps of locating the plurality of sharp edges generally horizontal and the plurality of light sources having a light pattern of that is ovoid toward locations generally in front of the visual display such that the ovoid pattern has a longer horizontal dimension and shaping the series of connected “WWW” configurations formed by the plurality of adjacent pairs of opposed light reflective surfaces curve in a slight arc with respect to the horizontal such that when viewed in cross section the curvature is dished for trapping ambient light from locations generally in front of the visual display so that the dark area appears about each of the light emitting diodes during observation.

### BRIEF DESCRIPTION OF THE DRAWING

FIG. 1 illustrates the placement of the visual display for observation.

FIG. 2 illustrates a portion of the system of FIG. 1 showing light sources of the present invention as incandescent lights.

FIG. 3 illustrates a portion of the system of FIG. 1 showing light sources of the present invention as light emitting diodes.

FIG. 4 shows a partial side view of a support for the light sources of the present invention showing the preferred light absorber about the light emitting diodes.

FIG. 5 is a view of a light emitting diode in cross section showing the relative relationship of the emitter, reflector and lens.

FIG. 6 is a schematic diagram of the reflection of a light ray caught in the light absorber; the diagram is shown with but one of the light rays for illustrative clarity.

### DETAILED DESCRIPTION OF THE INVENTION

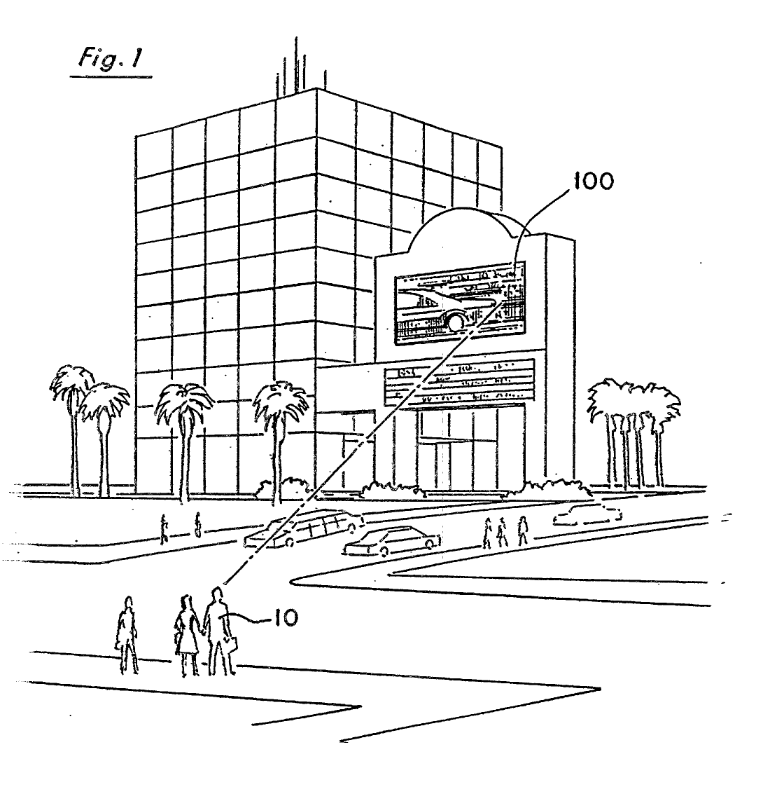

Turning to FIG. 1, a visual display 100 in accordance with the present invention is shown. Although the visual display 100 in FIG. 1 is shown as being in a preferred outdoor location, it is to be understood that the visual display 100 is not limited to outdoor placement and that it may also be situated within a structure. Therein the surrounding elements and support structure may vary from those shown in FIG. 1. For example, the visual display 100 can be placed flat against the exterior wall of a building or the interior wall of a room, or hang freely from the ceiling within a room, or stand atop the roof of a building. The visual display 100 is preferably situated to be easily visible to the viewers 10 who may be of some distance from and below the visual display 100.

The mounting location of the visual display 100 should be convenient for cleaning or servicing and not dependent on the variation of, direction of or amount of ambient light to which the visual display may be subject. Hence, the present invention permits locating the visual display 100 inside, outside and toward more, less and/or varying ambient light conditions. The visual display 100 for observation has a structure 101 for mounting the visual display in position for observation of the visual display from locations generally in front of the visual display, as best shown in FIG. 1.

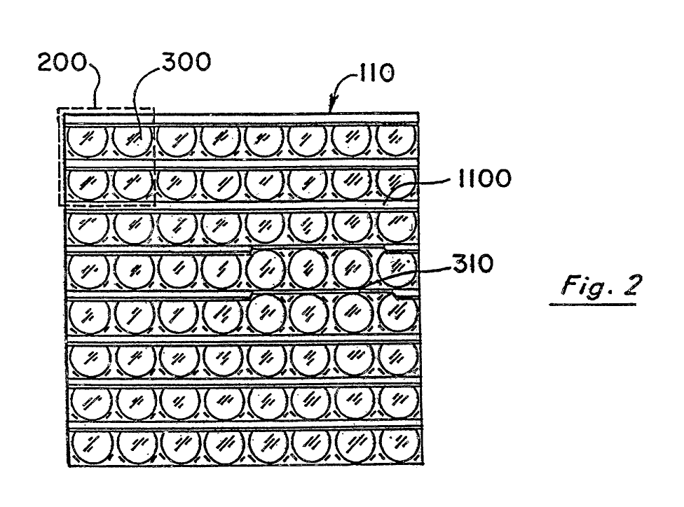

FIG. 2 illustrates four modules 110 of incandescent, cold cathode fluorescent or any other available or suitable light sources 300 for the embodiment of the visual display 100. It should be appreciated that the particular light source while important to the visual display 100 is interchangeable and with the energy conservation needs of present day the disclosure herein includes any light source 300 that skilled artisans could or would know about for use with the an ambient light absorber 400 disclosed herein after in detail.

Each module 210 in FIG. 2 preferably comprises four pixels 200 by a dashed line. Each pixel 200 with incandescent or cold cathode fluorescent lights has four individual lighting sources 300 arranged in a square two across and two deep. For Incandescent there would be two blue, one red and one green bulb. This is because there is less blue light available in the spectrum of incandescent light. Similarly, for cold cathode fluorescent or light emitting diode light sources 300 wherein the intensities are roughly equal there would be one red, one green and one blue light for each pixel 200.

For incandescent light sources 300 the wide spectrum of light is filtered through colored lenses to be more monochromatic, as in FIG. 2 wherein each filter lens resides in front of each light source 300. Each colored lens either red, blue or green and the light absorber 400 although reflective is observed from locations generally in front of the visual display as a dark area with essentially no observed reflected ambient light.

Light sources 300 have intensity tolerances that can vary widely so skilled artisans understand how to measure and balance light intensities so that the resulting visual displays look natural. One technique is to use more of the weakest intensity of color to offset the low output of that color. Thus a pixel 200 could have any number of red, blue or green light sources 300. The size of each lighting pixel 200 is immaterial under the teachings of the present invention. Depending on the size of the overall visual display 100 and the distance of the views 10 the number of pixels need to provide observable images can be designed by the skilled artisans.

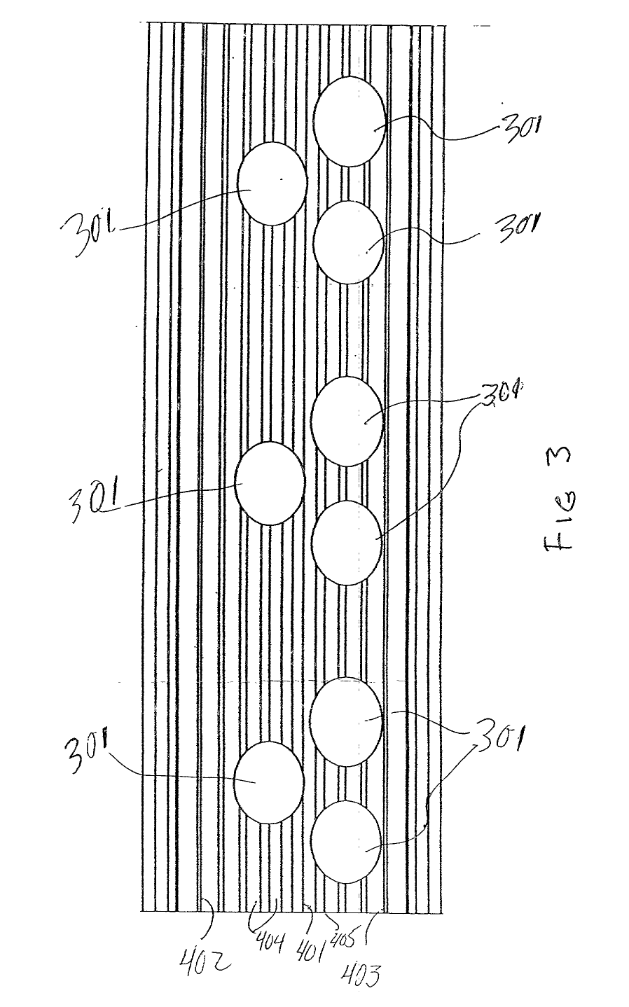

In FIG. 3 groups of light emitting diodes 301 are shown in lieu of the individual lighting modules 210 in FIG. 3. The light emitting diodes 301 although smaller in size are preferred because of their high efficiency relative to incandescent and if fluorescent light sources 300. Moreover, light emitting diodes 301 deliver monochromatic light having a narrow spectrum and so are better for use in pixels 200. With light emitting diodes 301 there remains dark space about each and that affords a contrast in the images seen by the viewers 10. The dark space or lack of light provides images that appear to have more definition or delineation so the lighting sources 300 seem brighter and clearer to the viewers 10.

In FIG. 3 a light absorber 400 mounts about the plurality of light sources 300. The light absorber 400 is configured for surrounding each of the plurality of light sources 300. The light absorber 400 is disposed for observation from locations generally in front of the visual display 100. The light absorber 400 is shaped to trap ambient light received by the visual display 100 from locations generally in front of the visual display 100 and to prevent the trapped light from being radiated therefrom for observation. The dark area of the light absorber 400 appearing about each of the light emitting diodes 301 during observation provides less returned ambient light and thus the dark areas appear darker and each light source 300 appears brighter.

The light emitting diodes 301 are preferred because there is proportionately more dark space about each which affords more contrast in the images seen by the viewers 10. Thus the images appear to have more definition or delineation and the lighting sources seem brighter and clearer to the viewers 10. The dark area represents a contrast background of the visual display defined by the electronic drive circuitry for controlling the delivery of power to the plurality of light emitting diodes. In particular, light emitting diodes 301 are smaller and so the pixels 200 thereof are also smaller; in FIG. 3 groups of three light emitting diodes 301 are shown in lieu of the individual lighting modules 110 in FIG. 2. FIG. 3 illustrates three groups of three light emitting diodes 301 (red, blue and green) as the light sources 300 for the embodiment of the visual display 100. Each group of three light emitting diodes 301 preferably comprises one pixel 200. Each pixel 200 is the group of three light emitting diodes 301 arranged in a triangle with two across the top and one centered below as shown in FIG. 3.

Each support 310 has preferably eight groups of light emitting diodes 301 forming eight pixels 200 on one support 310. Any number of pixels 200 can be formed of groups of light emitting diodes 301 and mounted on support 310 and electrically interconnected to form a visual display 100 of any desired size.

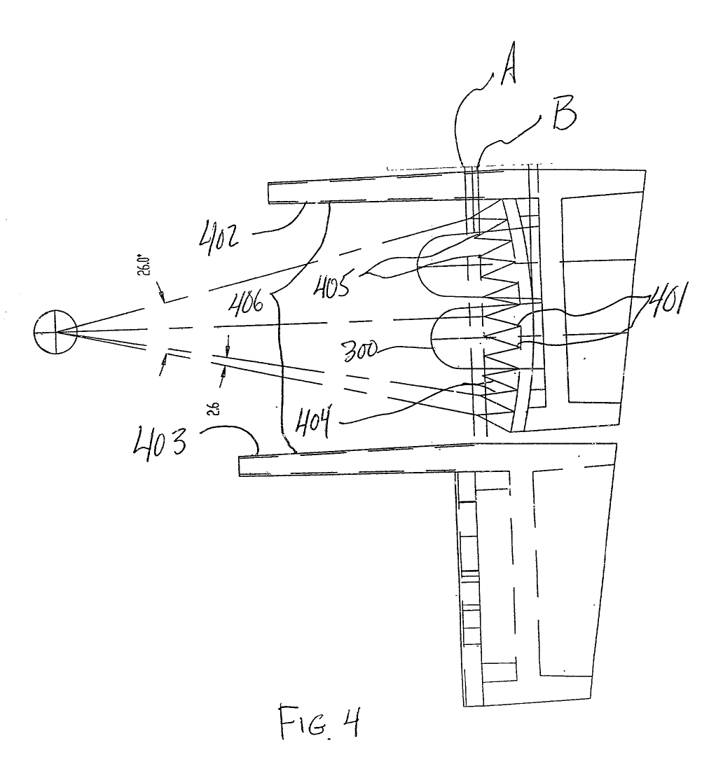

In FIG. 4, a partial side view of pixel 200 of the present invention showing the details of the preferred light absorber 400 about the light emitting diodes 301 as the light sources 300 as a portion of the support 310 including one row above another row in visual display 100. Support 310 can have any number of rows stacked atop one another and each row can be any length. The support 310 and all the pixels 200 thereon can be large or small with many or few light sources 300 such as incandescent lamps, cold cathode fluorescent, light emitting diodes 301 or the like and their associated drive circuitry as more fully explained in the following.

Each light absorber 400 includes at least one narrow crevice 401 for absorbing light but has in the embodiment shown in FIG. 4 eleven crevices. Each light absorber 400 is about 25 mm high and 203 mm across for a typical embodiment. The light absorbers 400 with light emitting diodes 301 can be stacked and set side by side and electrically interconnected to form a visual display 100 of any desired size. Each support 310 when stacked atop another support 310 as in FIG. 4 has a shade 402 of the light absorber 400. Below is a balcony 403 for the light absorber 400 above to reflect stray ambient light from entering into the light absorber 400.

In particular, each light absorber 400 has a plurality of light reflective surfaces 404 facing locations generally in front of the visual display 100 so that pairs of light reflective surfaces 404 are opposed to one another. The angle between light reflective surfaces 404 is thirty degrees. Ambient light received is reflected there between and toward each narrow crevice 401 located whereat the pairs of light reflective surfaces 404 join acutely. Each pair of opposed light reflective surfaces 404 are acutely angled with respect to each other so that the received ambient light bounces between the acutely angled opposed light reflective surfaces 404 toward the narrow crevice 401 there between. Roughly ninety four percent of ambient light entering the light absorber shown in FIG. 4 and described herein is trapped and not returned to locations in front of visual display 100. Each reflection of the ambient light entering the acute angle of the pairs of reflective surfaces 404 diminishes the light such that typically less than only about six percent is returned to the viewers 10.

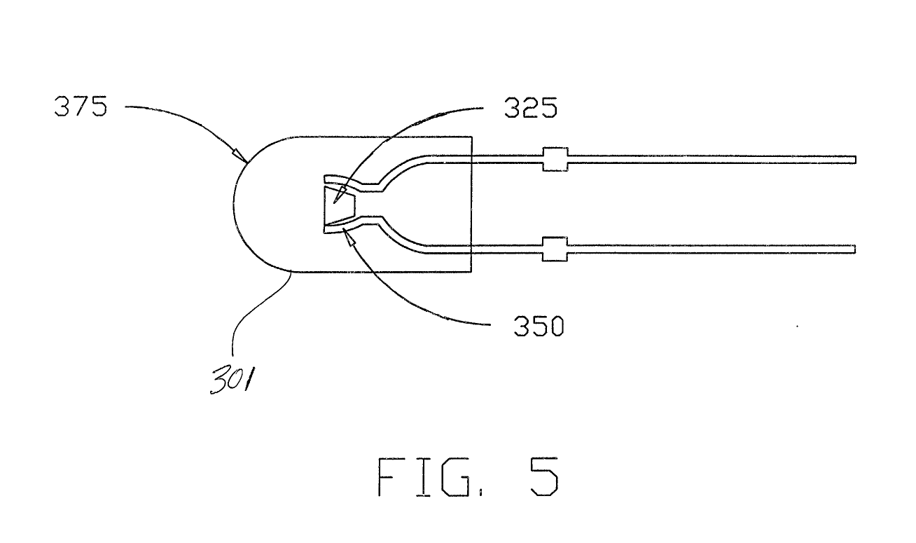

Each of the light sources 300 is, as shown and described in connection FIG. 3, one of a plurality of light emitting diodes 301. Each in FIG. 5 of the plurality of light emitting diodes 301 has a chip 325, a reflector 350 and a lens 375 for dispersion of light essential toward locations generally in front of the visual display 100. The lens 325 may be colored to transmit a particular light color. The reflector 350 is disposed generally normal to the direction of light transmitted from the light emitting diode 301 and received from the ambient. The reflector 350 is located in either plane A or B in FIG. 4 spaced a preset distance from the narrow crevices 401. The reflector 350 faces toward the direction of locations generally in front of the visual display 100. Adjacent pairs of opposed light reflective surfaces 404 join at a plurality of sharp edges 405 facing locations generally in front of the visual display 100. As viewed in cross section in FIG. 4, the plurality of adjacent pairs of opposed light reflective surfaces 404 appear generally as a series of connected “WWW” configurations with their plurality of sharp edges 405 facing locations generally in front of the visual display 100. The plurality of sharp edges 405 are for splitting received ambient light so that the pairs of reflective surfaces 404 adjacent thereto in combination with the joining narrow crevices 401 located inwardly of the plurality of sharp edges 405 trap received ambient light. The series of connected “WWW” configurations formed by the plurality of adjacent pairs of opposed light reflective surfaces 404 preferably curve in a slight arc. So that when viewed in cross section as in FIG. 4, the curvature is dished relative to locations generally in front of the visual display for trapping ambient light.

The shades 402 and the balconies 403 cooperate to block some of the ambient light received from above and below the visual display 100. Thus a narrow window 406 is formed between adjacent shades 402 and balconies 403, see FIG. 4.

The plurality of sharp edges 405 shown in the embodiment in FIGS. 3 and 4 are preferably located to be generally horizontal. The plurality of light sources 300 have a light pattern of that is ovoid toward locations generally in front of the visual display such that the ovoid pattern has a longer horizontal dimension.

The visual display 100 has many pixels 200 formed of light sources 300 with light absorbers 400 thereabout. The light emitting diodes 301 for each support 310 with eight pixels 200 couple to at least one circuit board 500 so a driving circuitry for the visual display 100 can illuminate the pixels as required by the instantaneous visual display. Each printed circuit board is behind the support 310 and includes electronic drive circuitry for controlling the delivery of power to the plurality of light emitting diodes 301 as required. Each eight pixels 200 couple to the printed circuit board via terminals.

In FIG. 4, the details of the particular construction necessary to include the light absorber 400 about the light emitting diodes 301 are shown. Similar constructions for incandescent lamps, cold cathode fluorescent or other lamps would be a mere substitution of light sources 300 within the skill of artisans in this field. Perhaps no more than scaling the size and openings of support 310 would be needed.

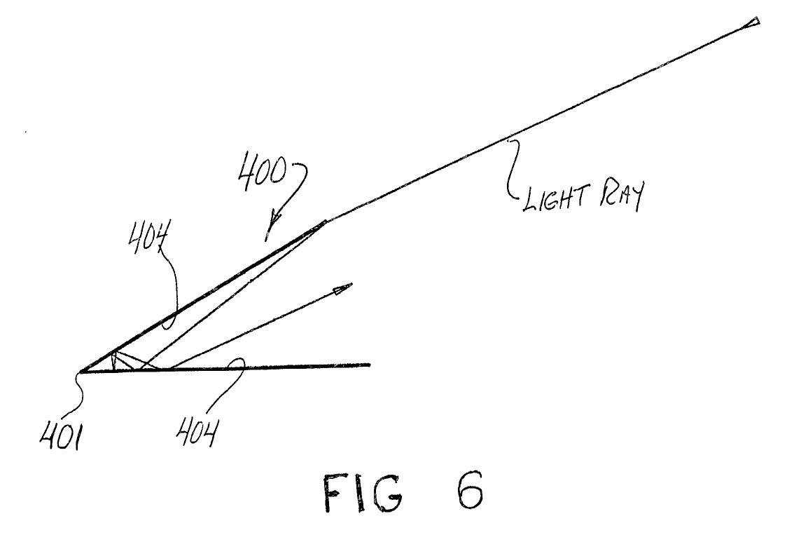

The FIG. 6 shows schematically the basic design and operation of the light absorber 400 on but one illustrative light ray. In FIG. 6 one portion of the light absorber 400 is shown in solid bolder lines as would be seen schematically in cross section. The light absorber 400 is comprised of two mirror like, reflective or specular surfaces 404 preferably arranged at 30 degrees to each other. To be specular in the context of this disclosure, roughness above a part of the wavelength of the light ray to be absorbed must not be on the subject reflective surfaces 404. By way of example, if the ambient light ray were all red having a wavelength of 650 nanometers then the specification for the surface finish for the specular or reflective surfaces 404 would have to be a fractional part of that wavelength or for example, 300 nanometers. If by lines per inch or by other metrics, the specular or reflective surface specification could also be defined to a degree that skilled artisans understand and can produce.

In order to illustrate or analyze how light will travel (bounce) in FIG. 6 within the light absorber 400 the reflective surfaces 404 are not shown unfolded as a the fan of black lines emanating or coming from the apex at the narrow crevice 401 of the light absorber 400. Unfolding the light rays is a common physicists' approach to illustrate many rays and the locations of the reflective surfaces 404. In FIG. 6 it is easier to illustrate and describe how one light ray will travel through the light absorber 400 if the light absorber is shown schematically and not in an unfolded layout. That is to explain that the reflective or specular surfaces 400 acutely angled at 30 degrees to each other are not shown as if they were rotated about their apex so there are a plurality of such reflective surfaces 404 angled at 30 degrees with respect to one another. The path of any light ray reflections are thus not diagrammed by using the unfolded layout in FIG. 6. The number of times the light ray is reflected (bounced) is still able to be counted and the angle of each bounce can be found from simple geometry. At each bounce the intensity of each received ambient light ray will be reduced ninety four percent if surface is black.

The lighter or phantom line represents a sample light ray that is passing through the light absorber 400 by reflective surfaces 404. Bouncing of that light ray occur each time it strikes one of the reflective or specular surfaces 404 as shown as a line in FIG. 6. The phantom line shows how that light ray would actually have bounced (six times) as it passed through and within the light absorber 400.

The method for absorbing unwanted ambient light is to allow the light to bounce between the reflective or specular surfaces 404 as many times as possible, because light intensity is lost by ninety four percent each time the light ray bounces. As the light rays enter along paths that are off the central or bisecting axis, there would be fewer bounces possible. Note that these off axis angles would for illustrative simplicity be in the plane of the paper. Light ray may also have an angle out of the plane of the paper at the same time. For example a light ray may strike the light absorber 400 at an angle of 60° to the paper, but be in a plane that is sixteen degrees off the axis of the light absorber 400. Such a light ray will still bounce four times before it leaves the light absorber 400. Thus it is preferred for this reason that the narrow crevices 401 of the light absorber 400 be horizontal, see FIGS. 3 and 4. The shades 402 above and balconies 403 below restrict the incident light to about plus or minus thirty degrees. A very wide spread of light in the horizontal might need to be dealt with by limiting ambient light to those rays that bounce in the light absorber 400 at least four bounces before returning to the viewers 10. The narrow crevices 401 are positioned on an arcuate or curved surface as shown in FIG. 4. The curvature orients the axis of each crevice 401 to face the preponderance of incoming light. Light striking the upper portion of the light trap approaches mainly from below whereas light falling on the lower portion of the light trap comes mainly from above.

Dust problems with the horizontal disposition of the narrow crevices 401 are no worse than any other orientation. Power washing may be used to remove dust accumulation. If horizontal orientation is a problem, the narrow crevices 401 may be position in the vertical direction, but there will be an inherent loss in effectiveness with any off axis orientation. Note also that the flat areas at the ends of the light shades 402 or balconies 403 are preferably of minimal or reduced size. Any reflection of ambient light from such ends may be reduced by putting an edge on it that the viewers 10 chance of observing that will be reduced. The bottom side of the shades 402 should be reflective or specular and the balconies should be diffuse if the viewers 10 can not see them.

The configuration of the printed circuit board 500, the type of light sources 300 and the design of the electronic drive circuitry are immaterial to the teachings of the present invention and could be of any suitable type including those disclosed in the references in the background of this disclosure that are now made a part hereof and are incorporated by reference. The claims which follow seek to include light absorbers that when used with light sources attenuate ambient light enabling any light source intensity to exhibit relatively more brightness, clarity and contrast. Those skilled artisans will appreciate that changes and modifications can be made to the disclosed structure of the light absorber, the light sources and their mountings without departing from the scope of the following claims.

I claim:

1. A visual display for observation comprising:
a support for mounting the visual display in position for observation of the visual display from locations generally in front of the visual display;
at least one board on the support, each board including driving circuitry for the visual display;
a plurality of light sources carried on each board, each light source having terminals for electrically coupling to the board so each board holds at least part of the plurality of light sources;
a light absorber mounted between the board and about the plurality of light sources, the light absorber configured for surrounding each of the plurality of light sources, the light absorber disposed for observation from locations generally in front of the visual display, the light absorber shaped to reduce reflection of ambient light received by the visual display from locations generally in front of the visual display and to prevent the ambient light from being radiated therefrom for observation.

2. The visual display of claim 1 wherein the light absorber includes at least one narrow crevice for absorbing light.

3. The visual display of claim 2 wherein the light absorber has a plurality of light reflective surfaces facing locations generally in front of the visual display so pairs of light reflective surfaces are opposed at an angle to receive ambient light and reflect it there between and toward the narrow crevice positioned whereat the pairs of light reflective surfaces join acutely.

4. The visual display of claim 2 wherein each of the light sources is a plurality of light emitting diodes.

5. The visual display of claim 4 wherein the board includes a printed circuit having electronic drive circuitry for controlling the delivery of power to the plurality of light emitting diodes.

6. The visual display of claim 4 wherein each of the plurality of light emitting diodes has a chip, a reflector and a colored lens for dispersion of light essential toward locations generally in front of the visual display, the reflector disposed normal to the direction of light transmitted from the light emitting diode and resting in a plane spaced a preset distance from the narrow crevice toward the direction of locations generally in front of the visual display lighting.

7. The visual display of claim 6 wherein each colored lens is red, blue or green and the light absorber although reflective is observed from locations generally in front of the visual display as a dark area with essentially no observed reflected ambient light.

8. The visual display of claim 7 wherein the dark area represents a contrast background of the visual display defined by the electronic drive circuitry for controlling the delivery of power to the plurality of light emitting diodes.

9. The visual display of claim 3 wherein each pair of opposed light reflective surfaces are acutely angled with respect to each other so that the received ambient light bounces between the acutely angled opposed light reflective surfaces toward the narrow crevice there between.

10. The visual display of claim 9 wherein adjacent pairs of opposed light reflective surfaces join at a plurality of sharp edges facing locations generally in front of the visual display so that if viewed in cross section the plurality of adjacent pairs of opposed light reflective surfaces appear generally as a series of connected “WWW” configurations with the plurality of sharp edges facing locations generally in front of the visual display, the plurality of sharp edges for splitting received ambient light so that the pairs of reflective surfaces in combination with the narrow crevices located inwardly of the plurality of sharp edges and positioned closer to the board to reduce received ambient light.

11. The visual display of claim 10 wherein the plurality of sharp edges are located generally horizontal and the plurality of light sources having a light pattern of that is ovoid toward locations generally in front of the visual display such that the ovoid pattern has a longer horizontal dimension.

12. The visual display of claim 11 wherein the series of connected “WWW”configurations formed by the plurality of adjacent pairs of opposed light reflective surfaces curve in a slight arc with respect to the horizontal such that when viewed in cross section the curvature is dished for trapping ambient light from locations generally in front of the visual display so that the dark area appears about each of the light emitting diodes during observation.

13. A visual display for observation comprising:
a support for mounting the visual display in position for observation of the visual display from locations generally in front of the visual display;
at least one board on the support, each board including driving circuitry for the visual display;
a plurality of light sources carried on each board, each light source having terminals for electrically coupling to the board so each board holds at least part of the plurality of light sources, each of the light sources includes a plurality of light emitting diodes, each board includes a printed circuit having electronic drive circuitry for controlling the delivery of power to the plurality of light emitting diodes;
a light absorber mounted between the board and about the plurality of light sources, the light absorber configured for surrounding each of the plurality of light sources, the light absorber disposed for observation from locations generally in front of the visual display, the light absorber shaped with at least one narrow crevice for absorbing ambient light received by the visual display from locations generally in front of the visual display and to prevent the ambient light from being radiated therefrom for observation, the light absorber having a plurality of light reflective surfaces facing locations generally in front of the visual display so pairs of light reflective surfaces are opposed at an acute angle to receive ambient light and reflect it there between and toward the narrow crevice positioned whereat the pairs of light reflective surfaces join acutely, the light absorber wherein adjacent pairs of opposed light reflective surfaces join at a plurality of sharp edges facing locations generally in front of the visual display so that if viewed in cross section the plurality of adjacent pairs of opposed light reflective surfaces appear generally as a series of connected “WWW” configurations with the plurality of sharp edges facing locations generally in front of the visual display such that adjacent pairs of opposed light reflective surfaces curve in a slight arc with respect to the horizontal such that when viewed in cross section the curvature is dished for trapping ambient light from locations generally in front of the visual display so that the dark area appears about each of the light emitting diodes during observation, the plurality of sharp edges for splitting received ambient light so that the pairs of reflective surfaces in combination with the narrow crevices located inwardly of the plurality of sharp edges and positioned closer to the board trap received ambient light so the plurality of sharp edges are located generally horizontal and the plurality of light sources having a light pattern of that is ovoid toward locations generally in front of the visual display such that the ovoid pattern has a longer horizontal dimension.

14. A method of absorbing ambient received on a lighted visual display having:
a support for mounting the visual display in position for observation of the visual display from locations generally in front of the visual display;
at least one board on the support, each board including driving circuitry for the visual display;
a plurality of light sources carried on each board, each light source having terminals for electrically coupling to the board so each board holds at least part of the plurality of light sources;
a light absorber mounted between the board and about the plurality of light sources:
the method of absorbing including the steps of:
surrounding each of the plurality of light sources with the light absorber disposed for observation from locations generally in front of the visual display;
shaping the light absorber to reduce reflection of ambient light received by the visual display from locations generally in front of the visual display and to prevent the ambient light from being radiated therefrom for observation;
including on the light absorber at least one narrow crevice for absorbing light;
having on the light absorber a plurality of light reflective surfaces facing locations generally in front of the visual display;
mounting pairs of light reflective surfaces opposed at an angle to receive ambient light and reflect it therebetween and toward the narrow crevice positioned whereat the pairs of light reflective surfaces join acutely.

15. The method of absorbing ambient light of claim 14 with the steps of providing the light sources with a plurality of light emitting diodes;
mounting the board includes a printed circuit having electronic drive circuitry for controlling the delivery of power to the plurality of light emitting diodes.

16. The method of absorbing ambient light of claim 15 with the step of:
joining adjacent pairs of opposed light reflective surfaces at a plurality of sharp edges facing locations generally in front of the visual display so that if viewed in cross section the plurality of adjacent pairs of opposed light reflective surfaces appear generally as a series of connected “WWW” configurations with the plurality of sharp edges facing locations generally in front of the visual display so that the plurality of sharp edges for splitting received ambient light so that the pairs of reflective surfaces in combination with the narrow crevices located inwardly of the plurality of sharp edges and positioned closer to the board to reduce received ambient light.

17. The method of claim 16 with the steps of:
locating the plurality of sharp edges generally horizontal and the plurality of light sources having a light pattern of that is ovoid toward locations generally in front of the visual display such that the ovoid pattern has a longer horizontal dimension;
shaping the series of connected “WWW” configurations formed by the plurality of adjacent pairs of opposed light reflective surfaces curve in a slight arc with respect to the horizontal such that when viewed in cross section the curvature is dished for trapping ambient light from locations generally in front of the visual display so that the dark area appears about each of the light emitting diodes during observation.
